(19) United States
(12) Patent Application Publication
(10) Pub. No.: US 2023/0096690 A1
(43) Pub. Date: Mar. 30, 2023

(54) METHOD AND APPARATUS FOR COORDINATING MULTI-ACCESS POINT COMMUNICATIONS

(71) Applicant: CANON KABUSHIKI KAISHA, Tokyo (JP)

(72) Inventors: Patrice NEZOU, LIFFRE (FR); Stéphane BARON, LE RHEU (FR); Pascal VIGER, JANZE (FR)

(21) Appl. No.: 17/911,275

(22) PCT Filed: Mar. 3, 2021
(86) PCT No.: PCT/EP2021/055327

§ 371 Date: Sep. 13, 2022

(30) Foreign Application Priority Data
Mar. 13, 2020 (GB) 2003708.1
Apr. 14, 2020 (GB) 2005358.3

(51) Int. Cl. H04W 16/10; H04W 72/12

(52) U.S. Cl. CPC H04W 16/10; H04W 72/1205

(57) ABSTRACT

To make effective the usage of wireless networks, and in particular IEEE 802.11 networks, it is described a method of coordinating communications comprising a group of access points, APs, sharing resources during a transmission opportunity, TXOP, gained by a first AP of the group, the first AP is configured to allocate resources to second APs of the group within the TXOP, wherein the group is formed based on the capabilities of the APs to share and/or use shared resources, and/or on the enablement status of the APs of their function to share and/or use shared resources.

### CROSS REFERENCE TO RELATED APPLICATIONS

This application is a National Stage Application filed under 35 U.S.C. 371 of International Application No. PCT/EP2021/055327, filed on Mar. 3, 2021, which claims the benefit under 35 U.S.C. § 119(a)-(d) of United Kingdom Patent Application No. 2003708.1, filed on Mar. 13, 2020 and entitled “Method and Apparatus for Coordinating Multi-Access Point Communications” and of United Kingdom Patent Application No. 2005358.3, filed on Apr. 14, 2020 and entitled “method and apparatus for coordinating multi-access point communications”. The above cited patent applications are incorporated herein by reference in their entireties.

### FIELD OF THE INVENTION

The invention relates to the technical field of wireless communication networks, and more particularly to methods and devices for coordinating communications of multiple Access Points (multi-AP) in IEEE 802.11 networks.

### BACKGROUND OF THE INVENTION

Multi-AP technology consists in enabling some degree of collaboration among neighbouring access points (APs) in order to have a more efficient utilization of time, frequency and spatial resources available. This is particularly important when the neighbouring APs operate over a same selected channel.

With such a technology, two neighbouring APs may share resources in terms of frequency and/or time and, in this way, they prevent interferences. APs that collaborate for sharing resources are referred to as coordinated APs. The AP that manages the collaboration is referred to as coordinator AP. Typically, the coordinator AP is the sharing AP, i.e. AP that gains the medium access right for a given period (referred to as transmission opportunity or TXOP) on a given channel, and a coordinated AP is shared AP, i.e. an AP that uses resource shared by the sharing AP. The coordinator AP may then share time/frequency resources within the given period between coordinated APs. A coordinated AP schedules then downlink (DL) and/or uplink (UL) transmissions for its associated non-AP stations within the constraints of its allocated resources.

However how to make neighbouring APs and associated basic service sets (BSSs) collaborate to share common resources is not addressed in the prior art. It is desirable to define efficient mechanisms to perform multi-AP operation.

### SUMMARY OF INVENTION

In such a context, the global objective of the invention is a communication method for coordinating multiple Access Points.

According to an aspect of the invention there is provided a method of coordinating communications in a wireless network comprising a group of access points, APs, sharing resources during a transmission opportunity, TXOP, gained by a first AP of the group, the first AP is configured to allocate resources to second APs of the group within the TXOP, wherein the group is formed based on the capabilities of the APs to share and/or use shared resources, and/or on the enablement status of the APs of their function to share and/or use shared resources.

In a preferred implementation, the first AP is a coordinator AP of the communications and the second APs are coordinated APs.

In one implementation, the resources are one or a combination of time resources, space resources and frequency resources.

According to a further aspect of the invention there is provided a frame designed to be sent by an access point, AP, of a first Basic Service Set, BSS, to an AP of a second BSS, the frame including an enablement field, wherein the enablement field indicates whether of the AP of the first BSS has enabled a function of allocating and/or sharing resources, gained by the AP of the first BSS during a transmission opportunity, TXOP, with the AP of the second BSS.

In particular, the AP of the first BSS is configured to support the function of allocating and/or sharing resources.

In a preferred implementation, the frame is a management frame.

According to a further aspect of the invention there is provided a coordinator access point, AP, in a wireless network comprising a group of APs sharing resources during a transmission opportunity, TXOP, gained by the coordinator AP of the group, the coordinator AP is configured to allocate resources to coordinated APs of the group within the TXOP, wherein the group is formed based on the capabilities of the APs to share and/or use shared resources, and/or on the enablement status of the APs of their function to share and/or use shared resources.

According to a further aspect of the invention there is provided a coordinated access point, AP, in a wireless network comprising a group of APs sharing resources during a transmission opportunity, TXOP, gained by a coordinator AP of the group, the coordinated AP is configured to use resources shared by the coordinator AP within the TXOP, wherein the group is formed based on the capabilities of the APs to share and/or use shared resources, and/or on the enablement status of the APs of their function to share and/or use shared resources.

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

### BRIEF DESCRIPTION OF THE DRAWINGS

Further advantages of the present invention will become apparent to those skilled in the art upon examination of the drawings and detailed description. Embodiments of the invention will now be described, by way of example only, and with reference to the following drawings:

FIG. 1 illustrates an example of a network environment in which embodiments of the present disclosure in its different aspects may be implemented:

FIGS. 2a and 2b show the format of an IEEE 802.11 MAC management frame and data frame respectively;

FIGS. 3a, 3b and 3c show different exemplary formats example for signalling multi-AP capabilities and/or enablement status of an AP;

FIG. 4 illustrates, using a flowchart, steps performed by a coordinator AP for coordinating a multi-AP transmission according to embodiments of the invention;

FIGS. 5a and 5b illustrate, using a sequence diagram, operation of APs involved in a multi-AP transmission according to embodiments of the invention;

FIGS. 6a, 6b and 6c illustrate, using flowcharts, possible implementations of embodiments of the invention for coordinating a multi-AP transmission; and

FIGS. 7a and 7b illustrate, using flowcharts, management of a group of APs according to embodiments of the invention.

### DETAILED DESCRIPTION

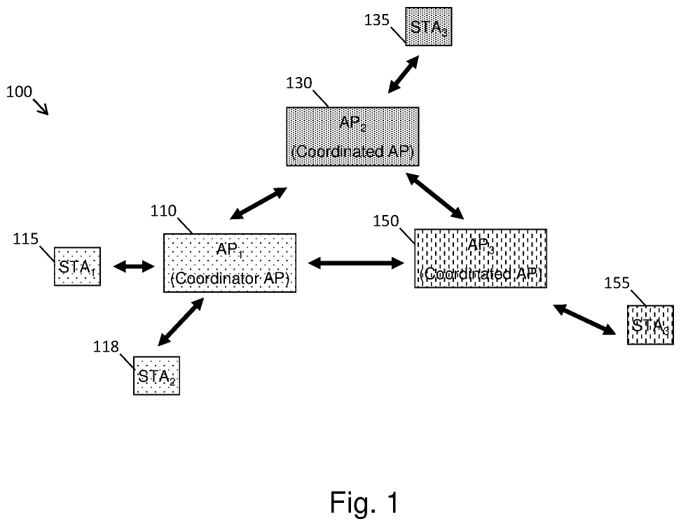

FIG. 1 illustrates an example of a network environment in which embodiments of the present disclosure in its different aspects may be implemented.

The illustrated network environment comprises a multiple AP system 100 formed by a group of neighbouring wireless networks. A first wireless network comprises an access point (AP) 110 and two non-AP stations (STAs) 115 and 118, a second wireless network comprises an AP 130 and one non-AP STA 135, and a third wireless network comprises an AP 150 and one non-AP STA 155. In the present disclosure, APs 110, 130 and 150 are also referred to, respectively, as AP1, AP2 and AP3.

Although not illustrated, note that it is not excluded that a device may act as an AP of one wireless network and at the same time may belong to another wireless network as an associated STA.

The wireless networks of the system may operate over a common communication channel that the APs can share and for which they need coordination to avoid interference. The APs may also use the common communication channel to exchange messages with each other for coordinating multi-AP communications. The common communication channel may correspond to a part (e.g. 20 MHz) or all of an operating channel (e.g. 20 MHz, 40 MHz, 80 MHz or 160 MHz).

Resources are defined over the common communication channel for sharing between APs. The resources may include space, frequency and time resources and may be obtained according to different orthogonal multiplexing schemes. Examples of those schemes include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An amount of a shared resource may be measured in time units, frequency band width, number of streams, amount of data or traffic (e.g. number of bytes) and/or any other suitable unit.

In the IEEE 802.11 wireless local area networking standards, the multiple AP system 100 may correspond to an extended service set (ESS) and each of the wireless networks to a basic service set (BSS).

Although the description of embodiments of the invention is given in the context of IEEE 802.11, the embodiments are not limited thereto and they may apply to other types of wireless networks and protocols.

Multi-AP Capabilities & Enablement

According to embodiments of the invention, APs of the group of neighbouring wireless networks (neighbouring APs) may have different capabilities and may be in different enablement status regarding the coordination of multi-AP communications. An AP may not have the multi-AP capability by design, i.e. it does not support or implement the underlying functions for multi-AP communications, and thus acts as a legacy AP. Or an AP may have the multi-AP capability, i.e. it implements one or more functions underlying the multi-AP capability. According to embodiments of the invention, an AP that is multi-AP capable may still have the possibility to enable or disable its multi-AP function. In other words, an AP that is multi-AP capable may be configured to disable (or enable) the multi-AP function, for example when one or more conditions are satisfied.

The multi-AP capability may be treated en bloc (globally) that is either supported or not. Also, the multi-AP enablement may be treated en bloc (globally) that is either enabled or not. In a variant, capability and enablement status may apply partially to the multi-AP function. In other words, some underlying functions may be supported or enabled, and others not.

For example, the multi-AP function may include an underlying function of sharing resources with other APs and another function of using resources shared by other APs.

Resources that are shared by a first AP and used by a second AP may represent any type of resources (e.g. frequency, space and/or time resources) the first AP gained during a transmission opportunity (TXOP). Preferably, the device that coordinates the multi-AP communication (coordinator) is the AP that gained the medium (first AP) and the device that responds to the coordination (coordinated) is the AP that uses the shared resources (second AP).

According to embodiments of the invention, an AP that does not support the multi-AP function, supports none of the underlying functions. Conversely, an AP that supports the multi-AP function, supports at least one underlying function. Also, an AP that supports the multi-AP function, may enable part or all of the underlying functions.

According to embodiments of the invention, enablement of different underlying functions may be dependent on each other, i.e. the enablement has to comply with certain rules.

The rules may impose requirements. For example, an AP that disables its sharing function also has to disable its ability to use resources shared by another AP. Conversely, an AP that enables its ability to use shared resources has to enable its sharing function. This ensures fairness between APs.

The rules may be flexible or given preferences. For example, it may only be recommended for an AP that disables its sharing function to disable its ability to use resources shared by another AP. In a variant, an AP that enables its sharing function is not required to use a resource shared by another AP. Conversely, an AP that disables its ability to use shared resources, does not have to disable its sharing function.

According to embodiments of the invention, enablement of different underlying functions may be independent from each other.

For example, an AP may enable or disable its sharing function, i.e. its ability to share frequency, time and/or space resources the AP gained for a TXOP, independently of its enablement/disablement of its function of using resources shared by another AP. Conversely, an AP may enable or disable its function of using shared resources, i.e. its ability to use frequency, time and/or space resources shared by another (coordinator) AP, independently of its enablement/disablement of its function of sharing resources.

As discussed above, enablement of the multi-AP function may depend on the fulfilment of one or more conditions. A condition may be for example one of the following: load of the BSS (i.e. amount of data for which the AP has to or predicts to allocate resources in its own BSS), number of neighbouring APs, number of neighbouring APs that support the multi-AP function, number of neighbouring APs with the multi-AP function enabled, etc.

Signalling of the Multi-AP Capability & Enablement Status

According to embodiments of the invention, an AP may signal its multi-AP capability and/or status (enabled/disabled) using a data frame, a management frame, a control frame or a dedicated frame.

The signalling may be performed by the AP towards another AP (e.g. coordinator AP) or a group of APs by sending unicast frame or a multicast frame, respectively. The signalling may be performed by the AP towards all APs by sending a broadcast frame.

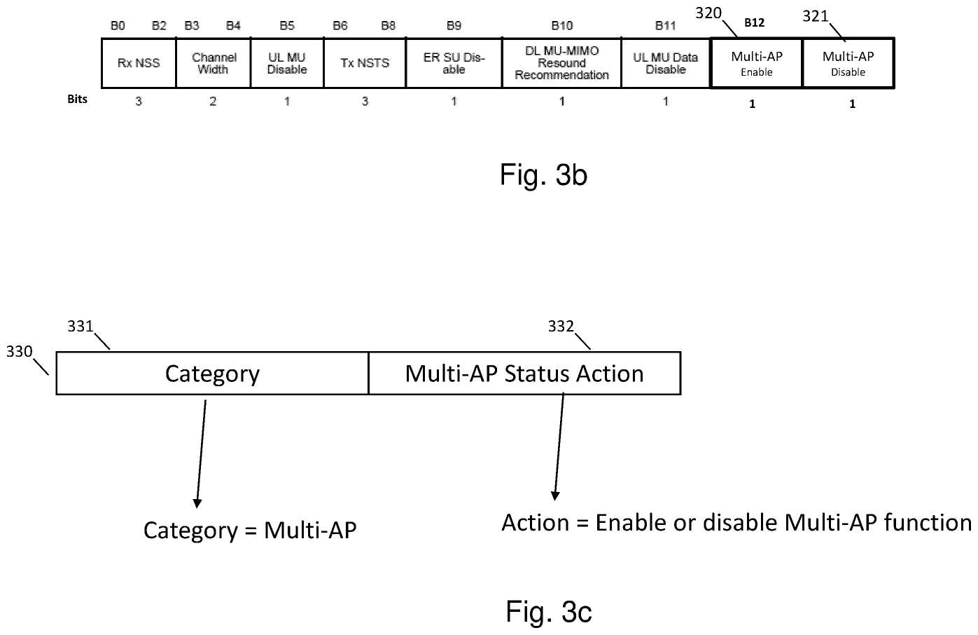

FIG. 3a shows an example format of an information element 301 that may be used to signal multi-AP capabilities and/or enablement status. The information element may be included in a management frame, such as a beacon frame.

The information element 301 may contain the following subfields: an Element ID subfield 310, a length subfield 311, a coordinator AP ID subfield 312, a multi-AP capabilities (support) subfield 313 and multi-AP Enable subfield 314. Note that the information element 301 may contain only one of the multi-AP capabilities subfield 313 and multi-AP Enable subfield 314.

The Element ID subfield 310 identifies the element as a Multi-AP element. It may take a value in the range [245-254], so far reserved in the standard 802.11. For the purpose of illustration, the value 246 is chosen in the embodiments of the invention.

The Length subfield 311 indicates the number of bytes in the element excluding the Element ID subfield 310 and the Length subfield 311.

The coordinator AP ID subfield 312 corresponds to an identifier of the coordinator AP. Preferably, it is equal to the BSSID of the coordinator AP. In a variant, it is equal to a specific AID.

The Multi-AP capabilities subfield 313 indicates whether the AP supports the multi-AP function or not. For instance, if the subfield has a value equal to 1 the Multi-AP is supported, and if 0 it is not.

The Multi-AP Enabled subfield 314 indicates whether the AP has enabled the multi-AP capability. For instance, if the subfield has a value equal to 1 the Multi-AP capability is enabled, and if 0 it is not.

In a variant, support and/or enablement of the Multi-AP underlying functions may be signalled. For example, in order to signal the support of the Multi-AP underlying functions, the multi-AP capabilities subfield 313 may contain a plurality of subfields (not illustrated), each for signalling support or not of one underlying function. A subfield for the support of the Multi-AP (global) function may be kept in addition to the other subfields, or can be omitted as the support of the multi-AP function can be derived from the support of the underlying functions.

Also, in order to signal the enablement of the Multi-AP underlying functions, the multi-AP Enabled subfield 314 may contain a plurality of subfields (not illustrated), each for signalling whether one underlying function is enabled or not. A subfield for the enablement of the Multi-AP (global) function may be kept in addition to the other subfields, or can be omitted as the enablement of the multi-AP function can be derived from the enablement of the underlying functions.

A Multi-AP underlying function may be, for example a function of sharing resources, a function of using resources, a function of acting as a coordinator AP, a function of acting as coordinated AP, etc.

As discussed above, information element 301 may be included for example in a management frame, e.g. beacon frame or a new type of management frame that can be exchanged between APs, to signal the Multi-AP capabilities and/or enablement status of an AP to its neighbouring APs.

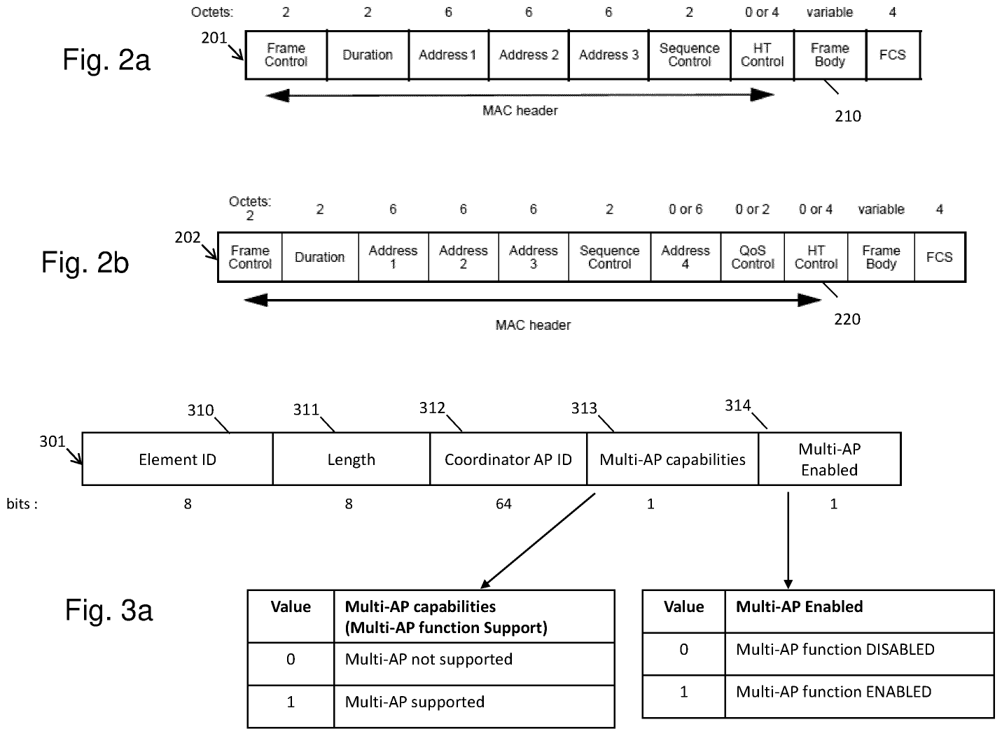

As an example, the information element 301 may be included in a frame body field 210 of an IEEE 802.11 MAC management frame 201 (FIG. 2a).

FIG. 3b shows an example format of a Control Information subfield in an Operating Mode (OM) subfield of IEEE 802.11 adapted according to embodiments of the invention.

The Control Information subfield in an OM Control subfield contains information related to the operating mode (OM) change of the device transmitting the frame. The OM Control subfield is included in HT Control field 220 of an IEEE 802.11 MAC data frame 201 (FIG. 2b).

The Control Information subfield is modified according to embodiments of the invention to signal multi-AP enablement status.

For example, two subfields may be added: a “Multi-AP Enable” subfield 320 and a “Multi-AP Disable” subfield 321. The “Multi-AP Enable” subfield 320 is added to enable the multi-AP function of multi-AP capable AP and the “Multi-AP Disable” subfield 321 is added to disable the multi-AP function of multi-AP capable AP.

In a variant, only one subfield “Multi-AP Enable” is added to signal whether (1) or not (0) the multi-AP function is enabled. In another variant, the “multi-AP Enable” subfield is not present and the multi-AP function is considered enabled by default if the Multi-AP function is supported. The “multi-AP Disable” subfield is then set to 1 if the disabling the multi-AP function is desired.

In a variant, enablement status of the Multi-AP underlying functions may be signalled. For example, the multi-AP Enabled subfield 320 may contain a plurality of subfields (not illustrated), each for signalling whether one underlying function is enabled or not. A subfield for the enablement of the Multi-AP (global) function may be kept in addition to the other subfields, or can be omitted as the enablement of the multi-AP function can be derived from the enablement of the underlying functions.

Note that the modified OM Control field can be inserted in a MAC frame intended to various destinations. The multi-AP function of an AP can be disabled for one neighbouring AP, a set of neighbouring APs or for all neighbouring APs.

FIG. 3c shows an example format of an Action frame 330 for signalling the multi-AP enablement status according to embodiments of the invention.

As specified in IEEE 802.11 standard, an Action frame provides a mechanism for specifying extended management actions. According to these embodiments, the Category field 331 indicates that the action frame is dedicated to the multi-AP function and the field 332 comprises the multi-AP enablement status indicating whether the multi-AP function is enabled or disabled.

The action frame can be unicast, multicast or broadcast. This allows advertising multi-AP function status to one neighbouring AP, a set of neighbouring APs or all neighbouring APs.

Operation of Coordinator/Coordinated APs

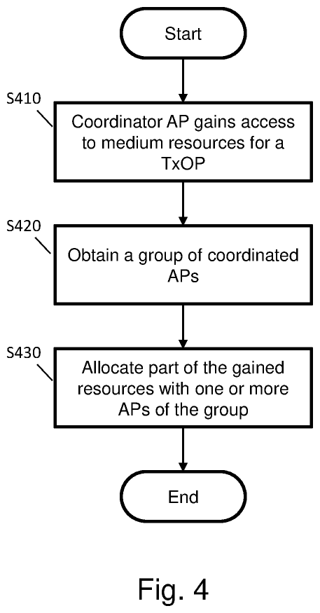

FIG. 4 illustrates, using a flowchart, steps performed by a coordinator AP for coordinating a multi-AP transmission according to embodiments of the invention.

At step S410, an AP gains access to medium resources (space, time and/or frequency) for a TXOP duration and becomes coordinator of the multi-AP transmission.

At step S420, the coordinator AP obtains a group of APs for participating to the multi-AP transmission. The group may be formed from a list of APs maintained by the coordinator AP. The list may contain detected neighbouring APs. The list may further contain information such as for example the multi-AP capabilities and enablement status of the detected APs. The group may then be formed based on the list, for example by including all detected APs if no further information is available about the capabilities and the enablement status of the APs. If information about the enablement status of the multi-AP function is available, it is preferable for the coordinator to construct the group based on whether the APs have enabled or not their multi-AP function. In particular, only the APs that signalled they have enabled the multi-AP function (or at least the underlying function of using shared resources) are included in the group. The group may be established before or after the coordinator AP gains medium access.

At step S430, the coordinator AP allocates part of the gained resources to one or more of the APs of the group.

An embodiment of the invention thus relates to a method of coordinating communications in a wireless network comprising a group of access points, APs, sharing resources during a transmission opportunity, TXOP, gained by a coordinator AP of the group, the coordinator AP is configured to allocate resources to coordinated APs of the group within the TXOP, wherein the group is formed based on the capabilities of the APs to share and/or use shared resources, and/or on the enablement status of the APs of their function to share and/or use shared resources.

Each AP of the group being itself configured to manage stations of a basic service set (BSS).

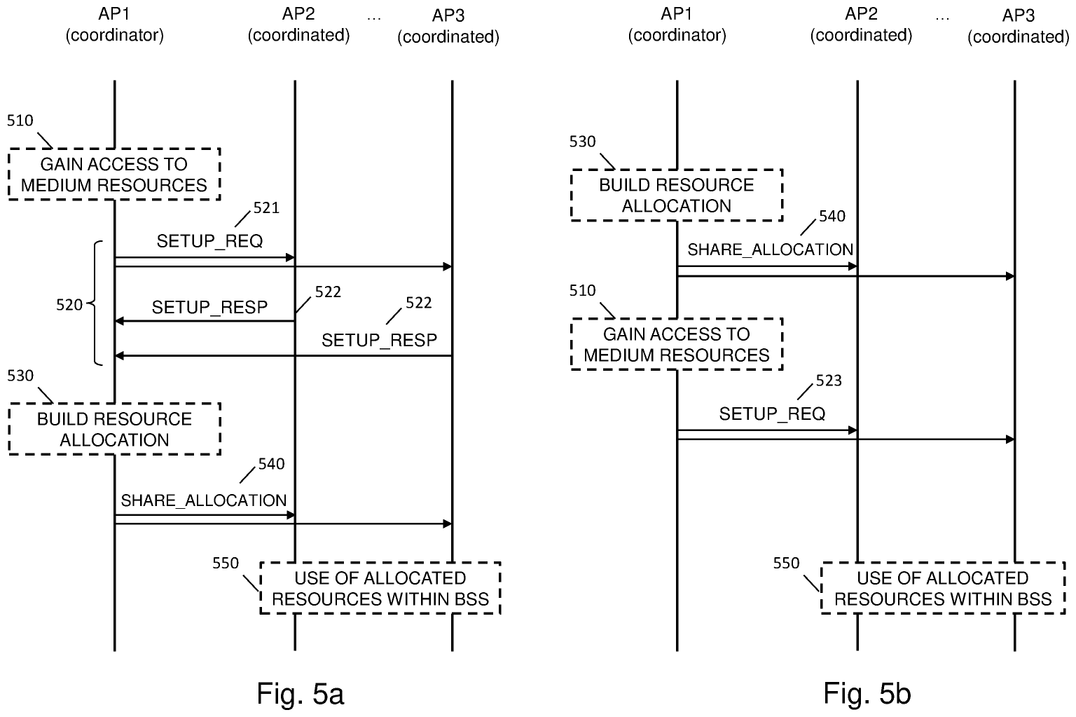

FIGS. 5a and 5b illustrate, using a sequence diagram, operation of APs involved in a multi-AP transmission according to embodiments of the invention. In the illustrated examples, the multi-AP operation involves one coordinator AP (AP1) and two coordinated APs (AP2 and AP3), but the embodiments apply to any number of APs.

Block 510 of the diagrams corresponds to step S410 of FIG. 4 in which AP1 gains access to medium resources for a TXOP duration and becomes coordinator of the multi-AP transmission.

In FIG. 5a, sequence 520 corresponds to an initialization phase that the coordinator may implement to achieve one or both of two main functions. The first one is for the coordinator AP to indicate/signal to coordinated APs that it gained the medium over the channel for a duration TXOP and is ready to initiate a multi-AP transmission. The second is for the coordinator AP to, optionally, request a response from the coordinated APs in order to know which coordinated APs intend to participate in the multi-AP transmission. Moreover, it may also request the resource needs of each coordinated AP which has the intention to participate.

The resource needs may correspond to an amount of resources needed, measured for example in time units, frequency band width, number of streams, amount of data or traffic (e.g. number of bytes) and/or any other suitable unit.

Two types of messages SETUP_REQ and SETUP_RESP may thus be exchanged during the initialization phase 520; a SETUP_REQ (521) message sent by the coordinator AP and a SETUP_RESP (522) message sent by a coordinated AP in response to the SETUP_REQ. The SETUP_REQ (521) may contain the indications discussed above (e.g. request for a response). The SETUP_RESP (522) may contain whether the coordinated AP intends to participate to the multi-AP transmission, and optionally its resource needs. In a variant, a coordinated AP responds to the coordinator AP request only if it intends to participate, i.e. absence of a response means that the coordinator AP does not intend to participate. This variant advantageously allows to handle cases where the coordinator AP is not available to send its response.

The SETUP_REQ message may be sent by the coordinator AP to target specific APs (e.g. by using as many unicast frames as necessary or multicast/group addressed frames). The SETUP_REQ message may also be sent by the coordinator AP using a broadcast frame to address all APs that are configured to decode the frame.

After the initialization phase 520, the coordinator AP builds a resource allocation by assigning resources to a group of coordinated APs (530). The resource allocation may include necessary information for an AP to locate a resource allocated to it, if any. Basically, the allocation may include one or more of the following: the BSSID of the AP to which the resource is allocated, the channel number or width of the allocated frequency band (e.g. number of tones), the start time/duration or TXOP of the resource. Note that one or more of the information items may be implicit or pre-defined and thus are not communicated to coordinated APs (cf. 540). For example, an AP may dedicate a specific resource (agreement upon beforehand between APs) for sharing if not used by the AP. In this case, the AP has only to indicate the availability or not of the resource.

The group of APs to which resources are allocated may be based on the group of APs to which a SETUP_REQ message has been sent. The group of APs to which are allocated resources may be a subset of the first group or a superset of it. Details on the groups forming is detailed later on in this specification.

If the coordinator AP collects coordinated APs resource needs, e.g. via the SETUP_RESP messages, the coordinator may use the resource needs to build the resource allocation, and in particular to decide how much resources are allocated to each coordinated AP. Alternatively, or in addition, the coordinator AP may consider for allocating resources a set of rules that may be pre-defined, for example.

The coordinator AP then shares the built allocation to the concerned APs by means of dedicated messages SHARE_ALLOCATION (540). The allocated resources are used by each coordinated AP within its BSS, i.e. used by the AP or by STAs to transmit data (550).

FIG. 5a illustrates a multi-AP operation wherein a coordinator AP builds a resource allocation after gaining access to medium resources. This advantageously allows the AP to build a resource allocation based on the actual amount of resources the AP gained and the latest needs of the coordinated APs, and hence usage efficiency of the resources is enhanced.

FIG. 5b illustrates a multi-AP operation wherein a coordinator AP builds a resource allocation prior gaining access to medium resources. This advantageously allows time for the coordinated APs that got resource allocation to schedule transmissions within their BSSs.

Building of resource allocation (530) and sharing the allocation (540) are performed prior the coordinator AP has gained access to medium resources (510). The allocation may be built based on coordinated APs resource needs previously collected. Alternatively, or in addition, the coordinator AP may consider for allocating resources a set of rules that may be pre-defined, for example. SETUP_REQ message (523) is optionally used for its function to indicate/signal to coordinated APs that coordinator AP has gained the medium over the channel for a duration TXOP. It may also be used to signal that the AP is ready to initiate a multi-AP transmission.

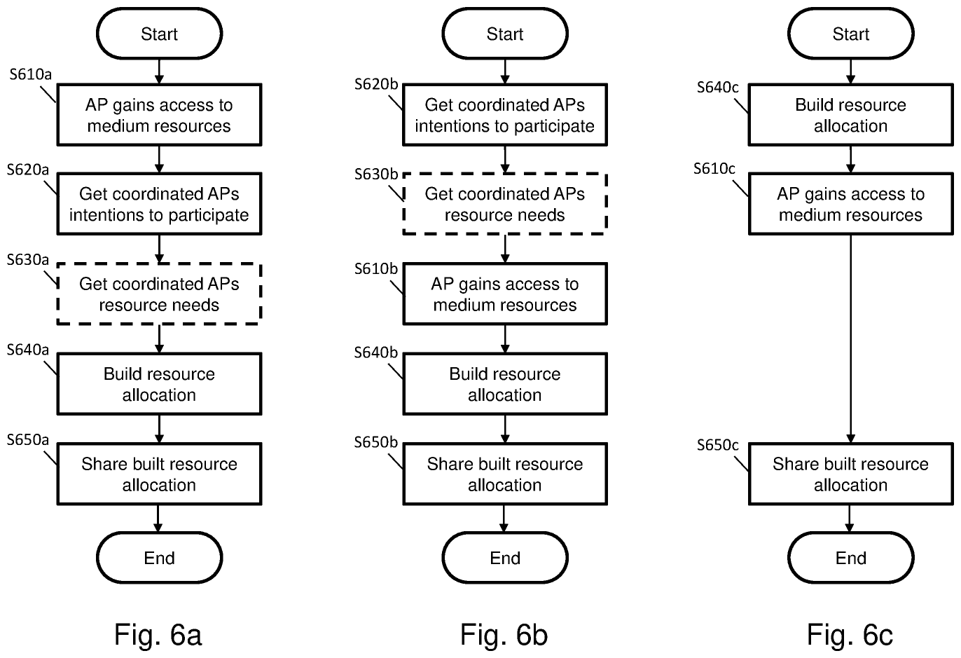

FIGS. 6a, 6b and 6c illustrate, using flowcharts, possible implementations of embodiments of the invention at one AP for coordinating a multi-AP transmission.

The flowchart of FIG. 6a presents a sequence of steps similar to what has been discussed with reference to FIG. 5a. In this implementation, the AP gains access to medium resources (S610a), gets coordinated APs intentions to participate (S620a) and optionally their resource needs (S630a), builds resource allocation (S640a) and shares the built resource allocation to a group of APs (S650a).

The flowchart of FIG. 6b illustrates a variant sequence of steps. In this variant, obtaining coordinated APs intentions (S620b) and their resource needs (S630b) are performed by the AP before gaining access to the medium (S610b). The steps of building resource allocation (S640b) and sharing the built resource allocation to a group of APs (S650b) are executed after.

The flowchart of FIG. 6c illustrates a further variant sequence of steps. In this further variant, the AP builds a resource allocation without an explicit or immediate input from the coordinated APs (S640c). After the AP has gained access to the medium (S610c), the AP shares the built resource allocation to a group of APs (S650c).

Multi-AP Group Forming

In a multi-AP operation, the coordinator obtains a group of APs to which resources can be shared by an AP that has gained access to resources. This may correspond to step S420 of the flowchart of FIG. 4 according to embodiments of the invention. The obtained group is referred to hereinafter as candidate group or set. It may also be referred to as eligible group or set. The coordinator forms then a group of APs, based on the candidate group, to which are allocated resources for use in their respective BSSs (e.g. step S430 in FIG. 4). The formed group is referred to as allocated group or set. The allocated group may be the same as the candidate group, part of the candidate group or may extend the candidate group by additional APs, as it is detailed hereinafter in this specification.

The coordinator function may be hosted by a master device or an AP elected for a period of time according to defined rules. The coordinator function may also be taken over by each AP which has gained access to medium resources (sharing AP) to give responsibility to coordinate the multi-AP operation to the AP that owns the resources. The latter is illustrated for example by the embodiments of FIG. 4. In the following, it is assumed that the coordinator is the sharing AP, i.e. the AP that has gained access to the resources to simply the description.

According to an embodiment of the invention, the candidate group is formed by a list of APs that are multi-AP capable, referred to hereinafter list L0. L0 is maintained for example by each AP that is multi-AP capable or multi-AP enabled, and may be obtained by different ways.

The coordinator may collect multi-AP capabilities of APs by means of signalling transmitted by the APs or by STAs associated with them. The transmission may be performed wirelessly over a unicast, multicast or broadcast link between the coordinator and an AP. The transmission may, alternatively or in addition, be performed over a wired link via a backhaul network for example or an internal connection if the coordinator and the AP are hosted by the same device (e.g. in the case of a physical AP hosting virtual APs).

The signalling may be performed by means of a multi-AP capabilities field indicating the support of the multi-AP operation and/or the support of one or more underlying multi-AP functions (e.g. field 313 depicted in FIG. 3a). The field may be embedded in an information element (e.g. information element 301 depicted in FIG. 3a) or in any suitable signalling field.

The multi-AP capabilities field may be sent in an existing or a new type of frame exchanged between APs. For example, if the transmission is performed over a wireless link, a management frame (e.g. a frame as illustrated in FIG. 2a) or a newly defined management frame may be used.

According to an embodiment of the invention, the candidate group is formed by a list of APs that have enabled their multi-AP function, referred to hereinafter list L1. L1 may be obtained by different ways.

For example, L1 may be obtained by checking the multi-AP enablement status of the APs of L0. Alternatively, L1 may be constructed independently from L0 by listing all APs that have enabled their multi-AP function.

Determining APs that have enabled their multi-AP function may rely on a signalling received by the coordinator from APs (or STAs), either in response to a request from the coordinator or without the APs being requested.

The coordinator may collect multi-AP enablement status of APs by means of signalling transmitted by the APs or by STAs associated with them. Signalling the multi-AP enablement status may be performed by means similar to those for signalling the multi-AP capabilities discussed above.

In particular, the signalling may be performed by means of a multi-AP enable field indicating the enablement status of the multi-AP operation and/or the enablement status of one or more underlying multi-AP functions (e.g. field 314 depicted in FIG. 3a). The field may be embedded in an information element (e.g. information element 301 depicted in FIG. 3a), in a Control Information subfield in an Operating Mode (OM) subfield defined in IEEE 802.11 (e.g. fields 320/321 depicted in FIG. 3b), in an action frame specified according to IEEE 802.11 (e.g. field 332 of frame 330 depicted in FIG. 3c), or in any suitable signalling field embedded in an existing or a new type of management frame capable to be exchanged between BSSs.

The multi-AP enable field may be sent in an existing or a new type of frame exchanged between APs. For example, the following frames may be used: a management frame (e.g. a frame as illustrated in FIG. 2a or a newly defined management frame), a control frame, a data frame (e.g. FIG. 2a), or an action frame (e.g. FIG. 3c).

Signalling the multi-AP enablement status may be intended for all APs (without distinction). The APs may potentially include APs willing to share their resources. Alternatively, the signalled status may apply per AP; i.e. an AP may signal its multi-AP enablement status to a specific AP or APs.

As discussed above in this specification, the signalled enablement status may apply to the multi-AP function globally, i.e. including all underlying functions such as using shared resources and sharing resources, or specifically to one or more underlying functions.

According to one implementation, L1 may be constructed by including only APs that have enabled their underlying function of using shared resources. This implementation is advantageous because the AP that maintains the candidate group based on L1 has a better knowledge on the needs or willingness of other APs to use shared resources, and thus to allocate resources more efficiently and reduce unused resources. Relying on the multi-AP enablement status globally may not be sufficient. In fact, an AP that has enabled its multi-AP function may not have, at a given time, enough data to be exchanged within its BSS to justify using resources shared by another AP. Also, an AP that is not configured to or does not implement signalling underlying functions, but only the multi-AP function, has to enable its multi-AP function to signal its willingness to share its own resource (when it gets granted access to medium resources) while it does not intend to use resources currently shared by a coordinator AP.

According to an embodiment of the invention, the candidate group is formed by a list of APs that have indicated their intention to participate to the multi-AP transmission, referred to hereinafter list L2. L2 may be obtained by different ways.

APs may signal their intention to participate by means of control frames. The signalling may be performed in response to a request control frame from the coordinator (e.g. control frame SETUP_RESP 522 that follows a control frame SETUP_REQ 521 in FIG. 5a). The signalling may also be at the initiative of the APs.

The signalled intention may apply for one, current or next, multi-AP transmission (i.e. multi-AP transmission related to when an AP gains medium access and can share it resources to other APs). Alternatively, it may last for a defined number of multi-AP transmissions or a period. In a further variant, the intention of the AP to participate or not may last until the AP updates its intention in a following control frame.

The signalled intention may apply without distinction to all APs willing to share their resources. Alternatively, the signalled intention may apply per AP; i.e. an AP may signal its intention to use resources shared by a specific AP or APs.

The signalled intention may apply to the multi-AP function globally, i.e. including all underlying functions such as using shared resources and intending to share resources in return when the AP gains its access to medium resources. Alternatively, the signalled intention may apply specifically to one or more underlying functions, e.g. intention to use shared resources.

According to an embodiment of the invention, the allocated group is formed by all the APs of the candidate group, i.e. the two groups are the same, as formed by any one of the lists L0, L1 or L2. The chosen list thus forming the allocated group according to this embodiment is referred to as L3.

According to an embodiment of the invention, the allocated group is formed by a list of APs, referred to as L4, that is a sub-list of L3, i.e. only part of the APs of L3 are included in L4. The APs selected to form L4 may be based on different criteria and may serve different purposes.

For example, the amount of resources the AP is capable of sharing may not be sufficient to serve all APs of the candidate group. In this case, selection of APs for forming L4 may be random, arbitrary or priority based.

In addition, or alternatively, the type of resources the AP is capable of sharing may not be compatible with what a candidate AP is capable of using, as for example a candidate AP may not be capable or configured to use resources shared in space or to operate in certain frequency bands over which the shared resources are located. In this case, selection of APs for forming L4 may consider those APs that can or are most likely to use the shared resources.

In addition, or alternatively, the amount of resources the AP has previously shared to a given AP may have reached an upper limit (credit) and thus the given AP may be excluded from the list of APs to which resources are allocated. The exclusion may be permanent or temporary, e.g. for a defined period of time. It may also depend on the amount of resources allocated to other APs to consider fairness between coordinated APs. The amount of resources may be measured in time units, frequency band width, number of streams, amount of data or traffic (e.g. number of bytes) and/or any other suitable unit. The amount of resources the AP has previously shared may be counted only during its last multi-AP transmission (TXOP). In a variant, the amount of resources may be counted for more than one multi-AP transmission during which the AP has shared resources. For example, the resources may be counted during a defined period of time, e.g. Target beacon Transmission Time (TBTT), or counted in a number of multi-AP transmissions. In this variant, the exclusion is performed if the cumulated amount of resources has reached the upper limit.

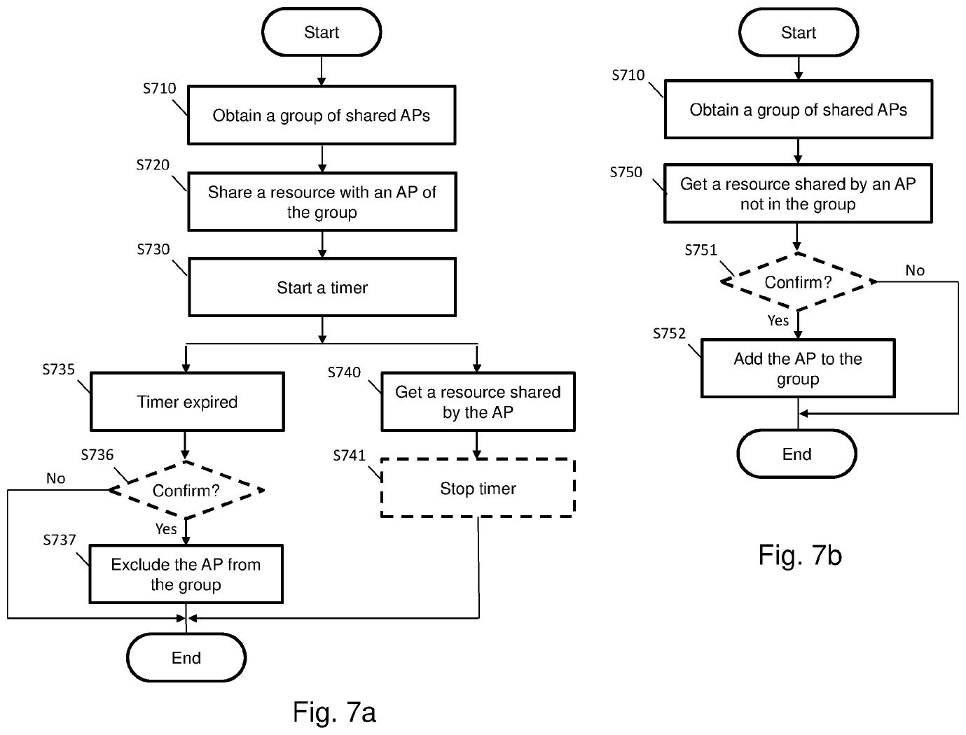

In addition, or alternatively, an AP may be excluded from the list of APs to which resources are allocated because that AP has not shared its resources in return. In this case, a reciprocity criterion may be applied to maintain a certain level of fairness. For example, an AP that has been allocated a resource and did not share its own resource in a following multi-AP transmission may not be kept in the list. The AP may be reintroduced again if it eventually shares a resource during a multi-AP transmission or after a defined period of time has elapsed since the AP was allocated the resource (cf. for example FIGS. 7a and 7b). Hence the coordinator AP may maintain one timer per coordinated AP. In a variant, a credit offset of shared resources may be set up between a pair of APs. When a first AP as a sharing AP allocates first resources to a second AP (as a shared AP), offset increases by the amount of allocated first resources and when the second AP as a sharing AP allocates second resources in return to the first AP (as a shared AP), offset decreases by the amount of allocated second resources. No more resources are allocated if the offset reaches the credit offset. The amount of resources may be measured in time units, frequency band width, number of streams and/or any other suitable unit.

In a variant, a first AP (acting as shared AP) that is specifically allocated a resource by a second AP (acting as a sharing AP), shall allocate a resource, when acting as sharing AP, to the second AP (acting as a shared AP) in a defined period of time.

In a variant, a sharing AP that has excluded a shared AP from its candidate group, notifies the shared AP about the exclusion, by means of a message for example.

In a variant, a sharing AP that has added a shared AP to its candidate group, notifies the shared AP about the addition, by means of a message for example. In a variant, the sharing AP notifies the shared AP only if the shared AP was added after it has been previously excluded (i.e. re-introduced).

According to an embodiment of the invention, the allocated group is formed by a list of APs, referred to as L5, that extends L3, i.e. in addition to the APs of L3, one or more APs are included in L5. The additional one or more APs may be based on different criteria. For example, when more resources are available than what is to be allocated to APs of the candidate group (e.g. based on their needs), additional APs may be added to benefit from the excess of resources. The additional APs may be requested to participate to the multi-AP transmission for them to be included in the transmission. In a variant, the additional APs are APs that has enabled their multi-AP function, joined the network or are considered high priority after the candidate group has been formed.

According to an embodiment of the invention, the allocated group is formed by a list of APs, referred to as L6, that combines the lists L4 and L5, i.e. part of the APs of L3 and one or more APs not part of L3 are included in L6.

FIGS. 7a and 7b illustrate, using flowcharts, management of a group of APs according to embodiments of the invention. The flowcharts illustrate the management of a candidate group of APs but it may also apply to an allocated group of APs.

FIG. 7a illustrates the exclusion of an AP from a candidate group if that AP has not shared in return resources in a defined period of time. FIG. 7b illustrates the inclusion of an AP to a candidate group if that AP has shared resources (for example after having been previously excluded).

At step S710 a sharing AP obtains a candidate group, for example according to any one of the embodiments described in this specification for forming a group. After the sharing AP allocates a resource to an AP of the group (S720), a timer is started (S730) to monitor if the shared AP to which has been allocated the resource, has shared in return to the initially sharing AP a resource during a period T. If the timer expired without the shared AP has shared a resource in return (S735), the shared AP is excluded from the candidate group (S737). Optionally, the sharing AP may check a condition (S736) to confirm whether the shared AP is to be excluded. The condition may be for example that the shared AP is not bound by a reciprocity rule, is a high priority AP or forms an exception. If the condition is fulfilled, the shared AP is not excluded. If prior expiry of the timer (i.e. within the period T), the initially sharing AP gets a resource from the shared AP (S740), and timer is stopped (S741) without excluding the shared AP from the group.

According to the embodiment of FIG. 7b, following an exclusion, or independently from that, when an AP has shared a resource and that AP is not in the group of candidate APs of the AP to which the resource was shared (S750), it is included in that group (S752). Optionally, a condition may be checked (S751) to confirm whether the AP that shared the resource is to be added. If the condition is fulfilled, the AP is not added to the group.

1. A method of coordinating communications in a wireless network comprising a group of access points, APs, sharing resources during a transmission opportunity, TXOP, gained by a first AP of the group, the first AP is configured to allocate resources to second APs of the group within the TXOP, wherein the group is formed based on the capabilities of the APs to share and/or use shared resources, and/or on the enablement status of the APs of their function to share and/or use shared resources.

2. The method according to claim 1, wherein the first AP is a coordinator AP of the communications and the second APs are coordinated APs.

3. The method according to claim 1, wherein the resources are one or a combination of time resources, space resources and frequency resources.

4. A frame designed to be sent by an access point, AP, of a first Basic Service Set, BSS, to an AP of a second BSS, the frame including an enablement field, wherein the enablement field indicates whether of the AP of the first BSS has enabled a function of allocating and/or sharing resources, gained by the AP of the first BSS during a transmission opportunity, TXOP, with the AP of the second BSS.

5. The frame according to claim 4, wherein the AP of the first BSS is configured to support the function of allocating and/or sharing resources.

6. The frame according to claim 5, wherein the frame is a management frame.

7. A coordinator access point, AP, in a wireless network comprising a group of APs sharing resources during a transmission opportunity, TXOP, gained by the coordinator AP of the group, the coordinator AP is configured to allocate resources to coordinated APs of the group within the TXOP, wherein the group is formed based on the capabilities of the APs to share and/or use shared resources, and/or on the enablement status of the APs of their function to share and/or use shared resources.

8. A coordinated access point, AP, in a wireless network comprising a group of APs sharing resources during a transmission opportunity, TXOP, gained by a coordinator AP of the group, the coordinated AP is configured to use resources shared by the coordinator AP within the TXOP, wherein the group is formed based on the capabilities of the APs to share and/or use shared resources, and/or on the enablement status of the APs of their function to share and/or use shared resources.

9. A non-transitory computer-readable medium encoded with a computer program comprising instructions adapted for the carrying out of each of the steps of the method according to claim 1 when the computer program is executed on a computer.

10. The method according to claim 2, wherein the resources are one or a combination of time resources, space resources and frequency resources.
